(19) United States
(12) Patent Application Publication
(10) Pub. No.: US 2010/0043234 A1
(43) Pub. Date: Feb. 25, 2010

(54) CHAIN SAW PROVIDED WITH A LUBRICATION DEVICE AND METHOD IMPLEMENTED FOR PERFORMING SAID LUBRICATION

(75) Inventor: Roger Pellenc, Pertuis (FR)

Correspondence Address: EGBERT LAW OFFICES, 412 MAIN STREET, 7TH FLOOR, HOUSTON, TX, 77002, US

(73) Assignee: PELLENC (Societe Anonyme), Pertuis (FR)

(21) Appl. No.: 12/527,676

(22) PCT Filed: Feb. 25, 2008
(86) PCT No.: PCT/FR08/00245

§ 371 Date: Nov. 4, 2009

(30) Foreign Application Priority Data
Feb. 26, 2007 (FR) 07 01357

(51) Int. Cl. B27B 17/12; F16N 7/38; F16N 29/02

(52) U.S. Cl. 30/123.4; 30/383; 30/515; 83/22

(57) ABSTRACT

Chain saw featuring an endless cutting chain (5), mounted turning around a drive sprocket and a guide bar (6) equipped with a guide rail, a motor (8) driving this cutting chain, through the intermediary of said sprocket, a storage tank (11) of a lubricating fluid, as well as a pump (13) impelling the lubricating fluid towards the guide bar/cutting chain assembly (5-6), from the storage tank (10), characterized in that said pump (13) is coupled to an electric drive motor (13a) which is independent of the motor (8) driving the cutting chain (5).

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention concerns a chain saw provided with a lubrication device for the guide bar/cutting chain assembly. It also deals with the method implemented for performing this lubrication.

2. Description of Related Art Including Information Disclosed Under 37 CFR 1.97 and 37 CFR 1.98.

Such tools with cutting chains, commonly called chain saws, are well known and are commonly used to cut up various materials (wood, concrete, bricks, tiles etc.). They include a cutting device constituted by an endless cutting chain mounted so as to turn around a drive sprocket and a chain guide generally of an oblong shape and equipped with a peripheral guide rail and a power source (for example constituted by a combustion engine or an electric motor) performing the drive of this chain, through the intermediary of said sprocket.

For the proper operation of a tool of this kind, it is indispensable to ensure efficient lubrication between the guide bar and the cutting chain in order to reduce the friction generating heat, loss of efficiency, accelerated wear and over-consumption of energy.

For this purpose, a lubrication fluid is stored in a tank where it is picked up before being directed, over an appropriate conduit, towards the guide bar/cutting chain assembly. The transmission of the lubrication fluid to the guide bar/cutting chain assembly is generally performed through the intermediary of a pump. It is sometimes obtained by gravity (not very efficient) or by pressurizing the storage tank (difficult dosage because it depends on the pressure and varies accordingly).

When the lubricating fluid is transported to the guide bar/cutting chain assembly by a pump, which is most often the case, this pump and the cutting chain are driven by the same motor or engine. Lubrication of the chain is then performed constantly and proportionally to the rotational speed of this motor or engine which leads to significant consumption of the lubricating fluid, without being necessarily always adequate for particularly difficult operating conditions which accompany a braking of the chain and a slowing down of the engine or motor, and consequently less lubrication of the chain.

The document FR 2 505 719 describes a device of this kind. According to this document, the electromagnetic lubricating pump of the chain saw is actuated by the combustion motor driving the chain of the chain saw, through the intermediary of a magneto and a micro-calculator.

More concretely, with the current lubrication methods and systems, proper dosage of the quantity of oil taken from the tank is difficult because the output of the pump increases with the rotational speed of the engine and can lead to the useless delivery of too large volumes of oil. Furthermore, since this speed is reduced when more force is required for the cut, one reduces also the quantity of oil delivered to the chain when this is the moment where good lubrication would be necessary in order to reduce overheating and wear.

The invention aims at least at improving the efficiency of the lubrication of the guide bar/cutting chain assembly of chain saws and their drive sprocket by reducing the consumption of lubricating fluid and avoiding splashing the operator which happens frequently and causes stains and burns.

### BRIEF SUMMARY OF THE INVENTION

According to the invention, this aim has been achieved by a chain saw featuring an endless cutting chain, mounted so as to turn around a drive sprocket and around a chain guide equipped with a peripheral guide rail, a motor driving this cutting chain, through the intermediary of said sprocket, a storage tank for a lubricating fluid, as well as a pump delivering a lubricating fluid to the guide bar/cutting chain assembly and to the drive sprocket, from the storage tank. The pump is coupled to an electric motor, that is independent of the motor (or engine) driving the cutting chain, and integrated in the tool.

According to another important characteristic arrangement, the electric motor of the pump is controlled by an electronic card, which receives data relative to at least one parameter and/or operating factor of said chain saw.

Preferably, the drive motor for the cutting chain is comprised of an electronic motor, and this electric motor is controlled by an electronic card.

According to an advantageous mode of execution, the electronic card controlling the electric pump receives data concerning the current consumed by the electric motor driving the cutting chain and/or relative to the torque of this motor, via the electronic card controlling said electric motor while said chain saw is being utilized.

Preferably, the electronic card controlling the electric pump receives data coming from the electronic card controlling the electric motor driving the cutting chain.

According to an interesting mode of execution, the electronic card controlling the electric pump receives and processes data emitted by one or several sensors.

According to one mode of execution, the chain saw features a sensor allowing transmitting to the electronic card controlling the electric pump, information concerning the temperature of the guide bar.

According to another mode of production, the electronic card controlling the electric pump is configured to utilize information relative to the rate of flow of the lubricating fluid.

Advantageously, the electronic card controlling the electric pump is configured to command an intermittent operation of the pump, in order to transmit doses of lubricating fluid to the cutting system.

Preferably, the electronic card controlling the electric pump is configured so that the delivery of successive doses is spaced at a substantially constant interval and so that the quantity of lubricating fluid in the doses is governed by at least one of the parameters or operating factors mentioned above.

Interestingly, the lubricating fluid pump is a positive displacement pump, for example a peristaltic pump, or a diaphragm pump, or a plunger pump, or a vane pump, or a gear pump.

Advantageously, a single electric storage battery supplies both the motor of said electric pump, and the drive motor of the cutting device, which, in this case, is constituted by an electric motor.

The chain saw can also feature a detection device for insufficient flow of lubricating fluid towards the cutting device and for triggering a visual or acoustic signal, if such an insufficient flow is detected.

According to another interesting characteristic arrangement of the invention, that is applicable to pole-mounted chain saws, according to which a saw head, comprising the different components of the cutting device and their drive system, is mounted at the high end of a pole. The lower end of which is provided with a control handle, the lubricating fluid storage tank and the electric pump for distributing this lubricating fluid are installed at said handle. A flow duct for the lubricating fluid connects the storage tank to the cutting device, this duct being preferably housed in said pole.

The aim of the invention is also a method for lubricating the cutting chain of a chain saw such as defined above, in which the outflow from the lubricating fluid distribution pump is controlled, based on the value of at least one operating parameter or factor of said chain saw.

Another advantageous characteristic of this method can be that doses of lubricating fluid are dispensed intermittently to the cutting device.

According to a mode of implementation of this method, the doses of lubricating fluid are dispensed by spacing the actuations of these doses at a substantially constant interval, said doses containing quantities of lubricating fluid based on said parameter or operating factor.

The lubricating device and method according to the invention offer several very interesting advantages:

they allow an entirely automatic dosing of the lubrication, thus resulting in a very significant reduction of the generated heat and wear of the guide bar/cutting chain assembly;

they produce a better dosing of the oil for a good operation of the cutting device, whatever the working conditions of the tool may be, resulting in significantly reduced oil consumption; and

they are suitable for hand-held chain saws as well as for pole-mounted chain saws.

### BRIEF DESCRIPTION OF THE SEVERAL VIEWS OF THE DRAWINGS

The invention will be better understood when reading the description below, provided solely as an example and with reference being made to the attached drawings.

FIG. 1 is a perspective view of a pole-mounted chain saw to which the invention can be applied.

FIG. 2 is a perspective view with a break-away portion, showing the chain saw equipped with the lubricating device for its cutting elements.

FIG. 3 is a block diagram of the lubricating device of FIG. 2 and an appertaining electric circuit.

### DETAILED DESCRIPTION OF THE INVENTION

Reference to said drawings is made to describe an advantageous although by no means limiting, example of production, of the chain saw and the method of implementation of its lubricating system according to the invention.

A pole-mounted chain saw is described hereafter but it is emphasized that the invention is also applicable to hand-held chain saws of all types (with a single handle, a raised handle etc.) intended for all kinds of work (pruning, forestry, sawing of various materials . . . )

FIG. 1 shows a pole-mounted chain saw which has a control handle 2 mounted at the lower end of a tubular pole 3, at the upper portion of which is mounted, in a free-turning manner, a cutting head 4.

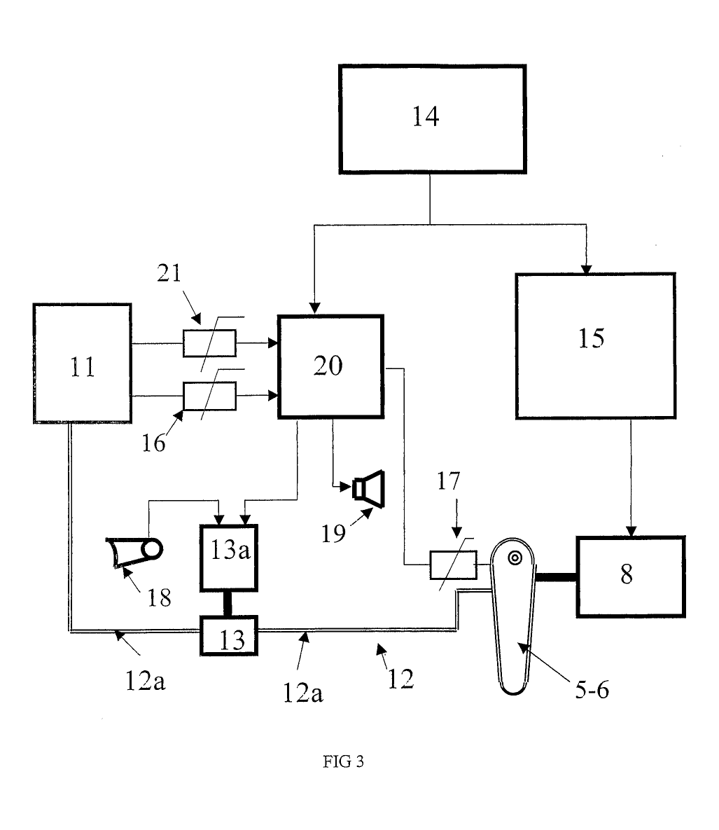

The cutting head 4 includes an endless cutting chain 5, mounted at the periphery of a guide bar 6 and a drive sprocket 9. The drive of this cutting chain 5, via the drive sprocket 9, is powered by an electric motor located inside a housing 7 in FIG. 1 and referenced by the number 8 in FIG. 3. One does not exclude the realization of this drive by means of a combustion engine.

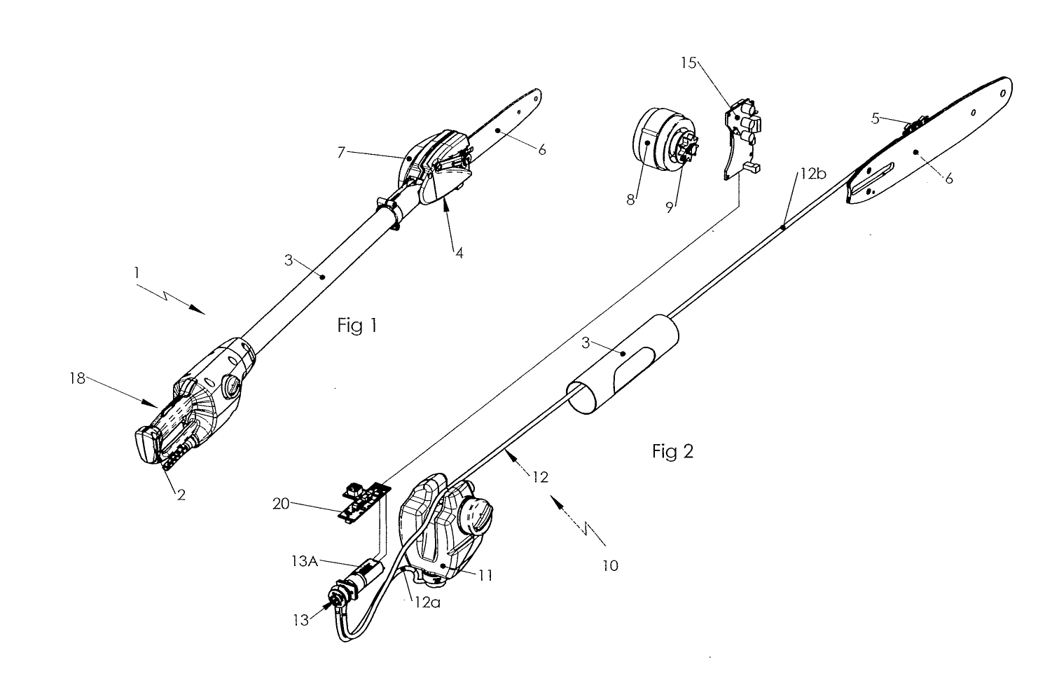

As one can see in FIG. 2 in which the pole 3 is partially shown, a lubricating device of the cutting system (guide bar 6, chain 5 and drive sprocket) is mounted at the lower end of the pole 3, at the handle 2. This lubricating device designated in its entirety by the reference number 10 includes a storage tank 11 which is intended for containing a quantity of lubricating fluid such as oil and which communicates with a supply duct 12 to deliver this fluid to the cutting head 4. On this duct 12, a pump 13 is connected for the delivery of the lubricating fluid to said cutting head.

According to a first characteristic arrangement of the invention, the pump 13 is coupled to an electric drive motor 13a, which is independent from the drive motor 8 of the cutting chain 5 of the cutting device 5-6 and is an integral part of the tool.

Advantageously, the electric pump 13 is a positive displacement pump capable of delivering the lubricating fluid intermittently, in the form of successive doses, to the cutting head 4. Preferably, it is a peristaltic pump, which has the advantage of being simple, sturdy and reliable. However, the electric pump 13 delivering the lubricating fluid may be constituted by any other type of appropriate pump, such as a diaphragm pump, or a plunger pump, or a vane pump, or a gear pump.

The tank 11, the pump 13 and its electric drive motor 13a are accommodated in the housing delimiting the handle 2, from which exits the aspiration section 12a of the duct 12. The lift section 12b of this duct 12, preferably constituted by a flexible pipe, then advances inside the pole 3. In a manner known as such, it extends into the guide bar 6 in the form of a distribution hole made in the latter and coming out under the chain 5.

According to another important characteristic arrangement, the electric drive motor 13a of the pump 13 is controlled by an appropriately configured electronic card 20, and the chain saw features at least one sensor to be able to transmit, to said electronic card, information relative to at least one parameter or operating factor of said chain saw.

Reference is now made to the block diagram of FIG. 3 to describe more completely the lubrication system and method according to the invention.

Preferably, the drive motor 8 of the cutting chain 5 is constituted by an electric motor, and this electric motor is likewise controlled by an electronic card 15.

A single storage battery 14 of electric energy, preferably constituted by a portable battery, can supply both the motor 13a of the electric pump 13 as well as the electric drive motor 8 of the cutting device 5-6.

The electronic control card 20 of the electric pump receives data concerning the electric current consumed by the electric drive motor 8 of the cutting chain, and/or relating to the torque of said motor 8, via the electronic control card 15 of the latter, during operation of the chain saw.

The electronic control card 20 of the electric pump 13-13a receives and processes data sent from one or several sensors. For instance, the chain saw is equipped with:

a sensor 17 capable of transmitting, to the electronic control card 20, data concerning the temperature of the guide bar 6; and/or

a sensor 16 capable of transmitting, to said electronic control card 20, data relative to the rate of flow of the lubricating fluid, toward the cutting device 5-6; and

a sensor 21 capable of transmitting, to said electronic card 20, data concerning the level of lubricating fluid contained in the tank 11.

The electronic control card 20 of the electric pump 13-13a may be configured to control the variable speed drive of said pump, on the basis of at least one parameter derived from the data relative to the electric current consumed by the drive motor 8 of the chain saw, to the torque of this motor, and/or derived from the temperature sensor 17 of the guide bar 6, or from the sensor 16, or from the sensor 21 of the oil flow rate.

The electronic control card 20 of the electric pump 13-13a is advantageously configured to command intermittent operation of this pump in order to transmit doses or quantities of lubricating fluid, to the cutting system 5-6.

The electronic control card 20 is configured so that the delivery of successive doses of lubricating fluid is spaced at a substantially constant rate and so that the quantities of lubricating fluid are based on at least one of the aforementioned parameters or operating factors.

The drive pump 13 of the lubricating fluid is constituted by a positive displacement pump, for instance a peristaltic pump, or a diaphragm pump, or a plunger pump, or a vane pump, or gear pump.

Preferably, and as indicated above, the chain saw features a detection device 21 of an insufficient level of lubricating fluid in the tank 11. The insufficiencies of the oil flow or level, observed by the sensors result in the trigger, via the electronic control card 20, a visual or acoustic signal 19.

In the application of the invention to pole-mounted chain saws (FIGS. 1 and 2), according to which a saw head 4, comprising the various elements of the cutting device 5-6 and of their drive system 8, is mounted at the high end of a pole 3 the lower end of which is equipped with a control handle 2, the storage tank 11 of the lubricating fluid and the electric pump 13-13a for distributing this lubricating fluid, are installed near said handle 2. A duct 12a-12b for transporting the lubricating fluid connects the storage tank 11 to the cutting device 5-6 via said pump, this duct 11 being preferably housed in said pole 3.

In this application, the electronic control card 20 of the electric pump 13-13a may be installed near the handle 2, whereas the electronic control card 15 of the drive motor 8 of the cutting chain 5 may be positioned near the cutting head 4.

In other applications, such as the chain saws with a simple handle or with a raised handle, the components of the electronic control cards 15 and 20 maybe placed together on a single support and installed near the control handle of the tool.

Advantageously, the chain saw according to the invention also features an arrangement allowing direct actuation of the electric pump 13-13a from a manual control element, for example constituted by the trigger 18 that is accessible on the handle 2 of the took, so that, preferably continuously, oil can be sent to the guide bar/cutting chain assembly 5-6, without passing through the electronic control card 20 of said electric pump 13-13a. Such forced lubrication is for instance used to make the oil rise from the tank 11 to the cutting head 5-6 at the first commissioning of the tool, or when the oil circuit 12a is empty, before the actuation of the motor 8, or to obtain a bleed down of the oil distribution orifice made in the guide bar 6.

According to the method of the invention, the electric pump 13-13a for distributing the lubricating fluid is controlled by means of an electronic card 20 on the basis of at least one parameter or operating factor of the chain saw.

According to an advantageous mode of execution, doses of lubricating fluid are sent intermittently to the cutting device 5, 6.

Preferably, in this case, doses of lubricating fluid are sent, while spacing the actuations of these doses at a substantially constant rate, said doses containing quantities of lubricating fluid, which are based on said parameter or operating factor.

1. Chain saw comprising:
an endless cutting chain, mounted so as to turn around a drive sprocket and a guide bar and equipped with a guide rail and a drive motor for the cutting chain, through an intermediary of the sprocket;
a storage tank of a lubricating fluid; and
a pump delivering of the lubricating fluid towards an assembly of the guide bar and cutting chain from the storage tank, said pump being coupled to an electric drive motor, independent from the drive motor.

2. Chain saw according to claim 1, wherein said electric drive motor is controlled by an electronic card, receiving information relating to at least one parameter or operating factor, modulating flow of lubrication.

3. Chain saw according to claim 1, wherein said drive motor is comprised of an electric motor controlled by an electronic control card.

4. Chain saw according to claim 3, the electronic control card is configured to receive data being emitted from the electronic control card of the electric drive motor of the cutting chain.

5. Chain saw according to wherein the electronic control card of the electric pump and the electronic control card of the electric drive motor of the cutting chain are merged into one and the same electronic card.

6. Chain saw according to claim 3, further comprising:
a single storage battery supplying both the motor of said electric pump as well as the drive motor of the cutting device.

7. Chain saw according to claim 3, wherein the electronic control card of the electric pump receives data concerning the current consumed by the electric drive motor of the cutting chain via the electronic control card of said electric motor, during operation.

8. Chain saw according to claim 3, wherein the electronic control card of the electric pump receives data concerning torque of the electric drive motor of the cutting chain via the electronic control card of said electric motor, during operation.

9. Chain saw according to claim 2, wherein the electronic control card of the electric pump receives and processes data emitted by one or several sensors.

10. Chain saw according to claim 2, further comprising:
a sensor allowing transmission, to the electronic control card of the electric pump, of data concerning the temperature of the guide bar.

11. Chain saw according to claim 2, further comprising:
a sensor allowing transmission, to the electronic control card of the electric pump, of data relating to flow rate of the lubricating fluid.

12. Chain saw according to claim 2, wherein the electronic control card of the electric pump is configured to command the variable speed drive of said pump, on the basis of at least one parameter derived from the data relative to the current consumed by the drive motor of the cutting chain or to the torque of this motor, and/or transmitted by a temperature sensor of the guide bar, and/or by an oil flow sensor, and/or an oil level sensor.

13. Chain saw according to claim 2, wherein the electronic control card of the electric pump is configured to command an intermittent operation of this pump in order to send doses of lubricating fluid to the cutting device.

14. Chain saw according to claim 13, wherein the electronic control card is configured so that the delivery of successive doses is spaced at a substantially constant rate and that the quantities of lubricating fluid in the doses are based on at least one of the parameters and/or operating factors.

15. Chain saw according to claim 1, wherein the drive pump of the lubricating fluid is a positive displacement pumpmeans, such as a peristaltic pump, or a diaphragm pump, or a plunger pump, or a vane pump, or a gear pump.

16. Chain saw according to claim 1, further comprising:
a detection device of an insufficient flow of lubricating fluid towards the cutting device and triggering a visual or acoustic signal in case of detection of such an insufficient flow.

17. Chain saw according to claim 2, further comprising:
a control device of the level of lubricating fluid contained in the tank, the insufficiencies of flow determined by said control device resulting in the trigger, via the electronic control card of the electric pump, of a visual or acoustic signal.

18. Chain saw according to claim 1, of the pole-mounted chain saw type, further comprising:
a saw head, comprising different elements of the cutting device and drive system, and being mounted at a high end of a pole and having a lower end of which being equipped with a control handle, wherein the storage tank of lubricating fluid and the electric pump for distribution of the lubricating fluid are installed near said handle, with a duct for transporting the lubricating fluid, connecting the storage tank to the cutting device, said duct being preferably housed in said pole.

19. Chain saw according to claim 9, further comprising:
an arrangement allowing direct actuation of the electric pump from a manual command element so as to allow sending oil to the guide bar/cutting chain assembly.

20. Method of lubrication of the cutting device of a chain saw according to claim 1, the method comprising the steps of:
controlling flow from the electric distribution pump of the lubricating fluid by an electronic card on a basis of a value of at least one parameter and/or one operating factor of said chain saw.

21. Method of lubrication according to claim 20, further comprising the step of:
sending doses of lubricating fluid intermittently towards the cutting device.

22. Method of lubrication according to claim 21, wherein the step of sending doses of lubricating fluid is sent while spacing the actuations of these doses at a substantially constant rate, said doses containing quantities of lubricating fluid which are bases on said parameter or operating factor.
